(19) United States
(12) Patent Application Publication
(10) Pub. No.: US 2013/0290113 A1
(43) Pub. Date: Oct. 31, 2013

(54) DESIRABILITY BASED SALES SYSTEM

(71) Applicant: RKI APPS LLC, Philadelphia, PA (US)

(72) Inventor: Amer Qureshi, Staten Island, NY (US)

(73) Assignee: RKI Apps LLC, Philadelphia, PA (US)

(21) Appl. No.: 13/871,735

(22) Filed: Apr. 26, 2013

Related U.S. Application Data
(60) Provisional application No. 61/639,894, filed on Apr. 28, 2012.

(51) Int. Cl. G06Q 30/02

(52) U.S. Cl. CPC G06Q 30/0269
USPC 705/14.66

(57) ABSTRACT

A system that connects consumers with marketers by allowing marketers to post offers with a minimum desirability score or ranking that are made available to consumers that use a mobile or other device to access those offers and qualify for them based on a desirability score that is calculated for the user.

### RELATED APPLICATIONS

This application claims priority under 35 USC §119(e) from provisional application 61/639,894, filed Apr. 28, 2012, hereby incorporated herein by reference.

### BACKGROUND

1. Field of the Invention

The disclosed embodiments are in the field of Software Systems. More particularly, the disclosed embodiments are in the field of E-Commerce software platforms. More particularly, the disclosed embodiments are in the field of “deal-based” E-Commerce software platforms.

2. Background of the Invention

Advertising has evolved over the years to include the concept of offers or deals. Offers and deals, like coupons, are typically limited, promotional sales on a particular product or service or event. In the early 2000s the “deals” or “daily deals” class of E-Commerce website was born. The current state of the art of this class of software application provides a platform that connects merchants selling products with consumers buying those products. Specifically, these software systems enable a merchant to offer a much discounted offer to a large group of consumers simultaneously. The proclaimed value to the merchant is that they get large exposure by attracting many customers that then supposedly through word of mouth talk about that merchant or their product—and the value to the customer is that they get steep discounts. These sites typically list offers provided by merchants and sell vouchers to a set of users. The purchase of the voucher is functionality provided by the “deal” website.

This model has some issues—specifically the merchant is required to give large discounts (50% off or more) to everyone—but everyone does not help in spreading the word about the merchant or product. Thus, there is a need in the art for a system that would provide variable discounts based on the desirability of a given consumer.

### SUMMARY OF THE INVENTION

The disclosed embodiments are directed to a software platform for connecting consumers with marketers wherein the desirability (such as social influence) of the consumer is calculated and based on this score or relative ranking against his peers, the consumer is given a more or less exclusive offer or incentive or discount. A key advantage of this invention is that it allows marketers to maximize word of mouth marketing by incentivizing those consumers that are most likely to provide word of mouth marketing advantages—as an example, it allows marketers to give a 90% discount to 2 or 3 people and give a 10% discount to all others. The advantage to this alternative to the typical “deals” system is that it takes into account the desirability of the consumer and accordingly matches them with more exclusive deals or offers or more exclusive pricing.

The above advantages of this invention are provided by a system in accordance with this invention. The system of this invention includes processing units and subsystems that maintain an offers database, a desirability database, and private consumer database.

In accordance with this invention a marketer lists offers on an offer portal web application, including information about the offer including a minimum desirability score or ranking. The ranking may be global or geographically limited. As an example, consider an offer that has a minimum desirability rating that is “top 1% of social influencers” with a maximum number of units of 2 and limited to the city of Philadelphia and with a corresponding price of zero dollars. A corresponding offer posted by the same marketer for the same product may have a minimum desirability rating that is “top 50% of social influencers” and a maximum number of units of 500 and limited to the city of Philadelphia and with a corresponding price of five dollars.

In accordance with this invention a consumer application is launched by a consumer on a mobile device such as a smart phone, or via a web browser and through the request of the user, connected to other internet services that the consumer users such as public social networking services or loyalty programs that the user is involved with. The consumer application is connected via a services layer to the offer database and a desirability engine. A user receives a desirability score (both absolute and as a ranking based on others in a specified geographical location (such as a city)). The user then sees a list of offers that they may qualify for based on their desirability score. Each offer has a minimum score associated with it. When the user invokes a check-in operation, or on some regular frequency, the consumer application refreshes the users desirability score and ranking and shows the user what changes occurred that affected their score. These changes are shown much like a bank statement, indicating the transactions that affected the users overall score. In the case where the desirability score is based on social influence, and the 3^{rd} party information sources include social networks, such transactions may include friend added, friend lost, follower added, follower lost, activity increased, activity decreased etc.

In accordance with this invention a user may select an offer and if the user qualifies for this offer (qualifying criteria may include the desirability of the consumer), they will reserve the offer and the system will decrement the number of available units. Upon reserving the offer, if the user qualifies for the offer, the offer will disappear from their offer list if the offer is designated to be a “one per customer” type of offer. The reservation of the offer will result in a redemption code (a unique character string or number) being emailed to the consumer user. This same code will be stored in the offer database so that the marketer can see that a reservation on one of the units was taken. Along with the redemption code, instructions are emailed to the consumer—these instructions were defined during the time the offer is posted to the offer portal by the marketer. The marketer then waits for the consumer to contact the marketer to identify themselves and claim the offer. Such a mechanism allows the marketer to establish a relationship with the consumer to build brand advocacy.

### BRIEF DESCRIPTION OF THE DRAWINGS

FIG. 1 illustrating a computer network that provides a system in accordance with this invention;

FIG. 2 illustrating a processing unit in components of the network in accordance with this invention;

FIG. 3 illustrating a flow diagram of a process for providing an offer portal interface in accordance with this invention;

FIG. 4 illustrating a flow diagram of a process for posting offers in accordance with this invention;

FIG. 5 illustrating a flow diagram of a process for previewing offers in accordance with this invention;

FIG. 6 illustrating a flow diagram of a process for viewing offer analytics in accordance with this invention;

FIG. 7 illustrating a flow diagram of a process for viewing offer commitments in accordance with this invention;

FIG. 8 illustrating a flow diagram of a process for providing a consumer interface in accordance with this invention;

FIG. 9 illustrating a flow diagram of a process for adding an information source in accordance with this invention;

FIG. 10 illustrating a flow diagram of a process for a check-in process in accordance with this invention;

FIG. 11 illustrating a flow diagram of a process for viewing transactions in accordance with this invention;

FIG. 12 illustrating a flow diagram of a process for viewing and committing to offers in accordance with this invention;

FIG. 13 illustrating a user interface of the consumer application with score view selected in accordance with this invention;

FIG. 14 illustrating a user interface of the consumer application with history view selected in accordance with this invention;

FIG. 15 illustrating a user interface of the consumer application with offer view selected in accordance with this invention;

FIG. 16 illustrating a user interface of the offer portal in accordance with this invention

### DETAILED DESCRIPTION OF THE INVENTION

The following description of exemplary embodiments of the invention is not intended to limit the scope of the invention to these exemplary embodiments, but rather to enable any person skilled in the art to make and use the invention.

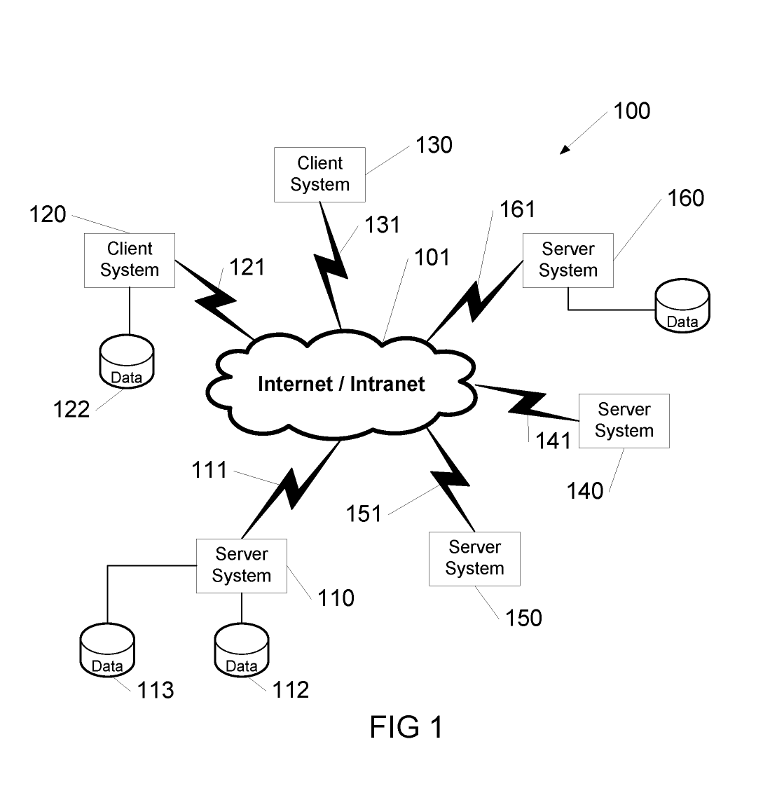

Referring now to the invention in more detail, in FIG. 1 there is shown a network 100 that provides a desirability-based deals system in accordance with this invention. Network 100 includes Internet or Intranet 101 that connects various processing systems in network 100 to allow the exchange of data between the processing systems, e.g., personal computers, system computers, mobile devices and other devices that can process digital data.

In network 100, the processing systems (110,120,130,140,150,160) are connected to the Internet/Intranet 101 via paths (111,121,131,141,151,161), e.g., digital cellular connections, Ethernet lines, or any other manner of connecting the processing systems.

Information server 160 is connected to Internet/Intranet 101 via path 161. Information server 160 is a router or other processing device that controls data transfers between processing systems connected to the Internet/Intranet 101.

A client device 130 such as a computer, laptop, tablet, mobile device, or other Internet enabled device is connected to Internet/Intranet 101 via path 131.

Offer Server 110 is connected to the Internet/Intranet 101 via path 111. Offer server 110 is a processing system that maintains various databases and provides services that are exposed to the Internet/Intranet 101 for access by other servers and systems. In Network 100 offer server maintains offer database 113 and desirability database 112. Additionally offer server 110 hosts a set of services that are exposed to the Internet/Intranet 101 and provide interaction with the offer database 113 and desirability database 112. Throughout this disclosure this layer of services may be referenced as the offer services layer.

Offer database 113 stores records for offers posted by marketers using web browsers running on client devices 130 for consumption by qualified consumer users that are using client devices 120. Additionally offer database 113 stores records for each reservation on an offer taken by a consumer using client device 120. Desirability database 112 stores records and measures for each consumer on the platform by geographic region. Desirability information may come from another external source and be populated into the desirability database 112. Statistics stored in the desirability database 112 include up to date desirability scores and rankings for each consumer user. Although desirability database 112 and offer database 113 are depicted in FIG. 1 as separate elements, these databases need not be separated physically and may in fact be combined in certain embodiments on a single storage unit and/or in the form of a single database.

External 3^{rd} party information servers 140 are connected to Internet/Intranet 101 via path 141. These external 3^{rd} party information servers may be hosting any number of web services or other application program interfaces (APIs) that enable software systems, with appropriate credentials to retrieve information about users and statistics about users' usage of the 3^{rd} party information servers or services. As an example consider that such 3^{rd} party information servers 140 are hosting services for popular social network services such as Twitter or Facebook.

Client device 120 is connected to the Internet/Intranet 101 via path 121. Client device 120 is a mobile device or computer that maintains its own private client database 122. The private client database 122 stores detailed information and statistics about the client's profiles at the 3^{rd} party information servers that the user authorized the system to collect. Additionally the private client database acts as a cache storing information that also resides on the offer database and desirability database, but only in relation to the specific user. The client device hosts a client application that runs within the context of the client device. In an alternate embodiment of the invention the client device may be any Internet enabled device and a separate server would be connected to network 100 and would provide a web site that has its own private client database 122. In this instance the client application would be a web site instead of an application running on a mobile device. Client device 120 via path 121 connects to Internet/Intranet 101 and interacts with offer server 110 to update the consumer's desirability into the desirability database 112 and then based on that desirability receive offers that come from the offers database 113 from the services layer executing on server 110.

Email Server 150 is connected to the Internet/Intranet 101 via path 151. Email Server is the standard email server that is known to those that are skilled in the art.

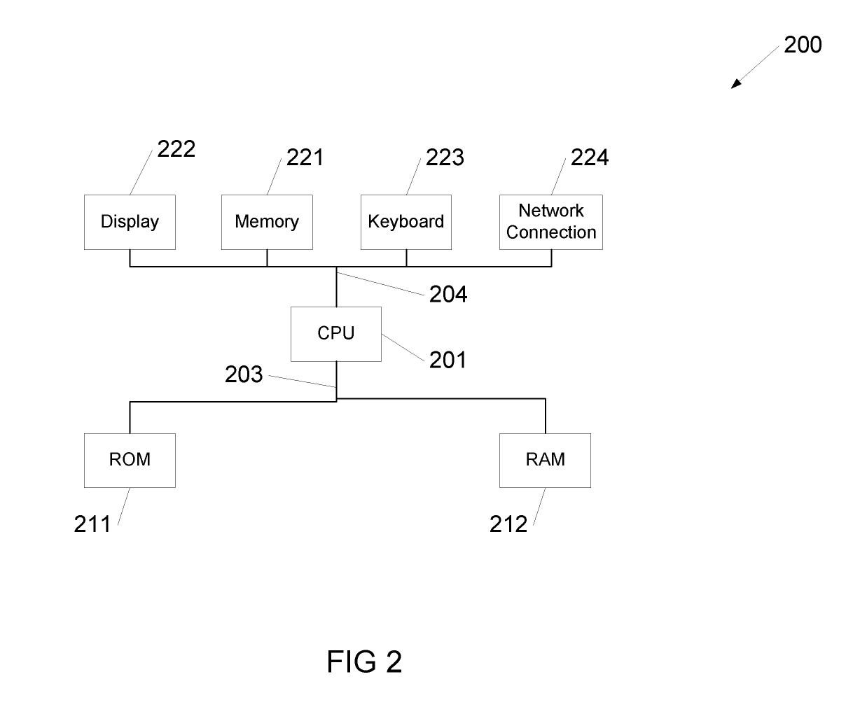

FIG. 2 illustrates an exemplary embodiment of a processing system 200 in which each device connected to network 100 in FIG. 1 includes a processing system. However, the exact configuration and device connected to the processing system in each individual device in the network may vary.

Processing system 200 has a Central Processing Unit (CPU) 201. CPU 201 is a processor, microprocessor, or any combination of processors and microprocessor that execute instructions stored in memory to perform an application. CPU 201 is connected to a memory bus 203 and Input/Output (I/O) bus 204.

A non-volatile memory, such as Read Only Memory (ROM) 211, is connected to CPU 201 via memory bus 203. ROM 211 stores instructions for initialization and other system commands of processing system 200.

A volatile memory such as Random Access Memory (RAM) 212 is also connected to CPU 201 via memory bus 204. RAM 212 stores instructions for all processes being executed and data operated upon by the executed processes. Other types of memories such DRAM and SRAM may also be used as a volatile memory and that memory caches and other memory devices (Not shown) may be connected to memory bus 204.

Peripheral devices including, but not limited to, memory 221, display 222, I/O device 223, and network connection device 224 that are connected to CPU 201 via I/O bus 204. I/O bus 204 carries data between the device and CPU 201. Memory 201 is a device for storing data unto a media. Some examples of memory 221 include read/write compact discs (CDs), and magnetic disk drives.

Display 222 is a monitor or display and associated drivers that convert data to a display. I/O device 223 is a keyboard, a pointing device or other device that may be used by a user to input data. Network device 224 is an Ethernet card or cellular connection card or wireless card that connects processing system 200 to a network. The exact configuration and devices connected to each processing system in network 100 may vary depending upon the operations that the processing system performs in the network.

The disclosed embodiments provide an integrated system for providing offers to consumers based on the consumer's desirability. An interface is provided that may access the offer database needed by a marketer to list offers on the system. The interface may be provided by software executed by a processing system at a work station, such as a desktop or laptop computer, or may be executed by a server that is communication with a workstation over a network using a browser or other access software.

When the marketer accesses the system the interface provides a display that will provide the marketer with the options available by the interface to the marketer. Preferably, the display is a “Windows” type display with activation “buttons” for each option, as discussed in further detail below. The user can then select an option by “clicking” on the activation button for the option using a pointing device such as a mouse. Alternatively, the interface may have various drop-down menus that may be scrolled through to select an option.

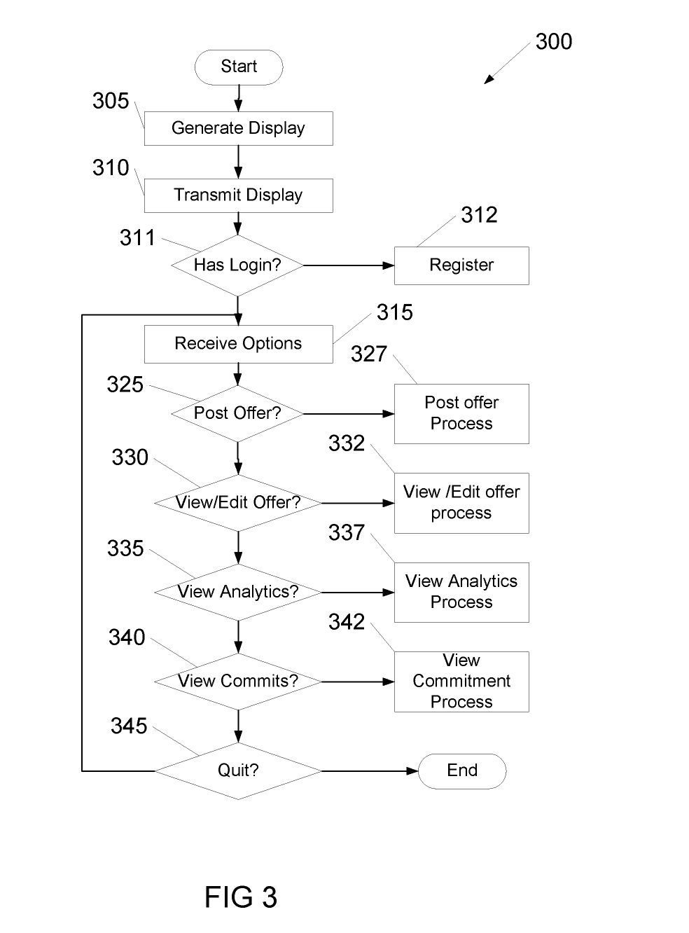

FIG. 3 illustrates a flow diagram of a process 300 executed to provide the interface using the above described display. Process 300 begins in step 305 in which the display is generated by the processing unit in the processing system executing process 300. In step 310, the display is then transmitted. If the processing system is accessing process 300 via a network connection, the processing system executing process 300 transmits the display to the workstation of the marketer. Otherwise, the display is transmitted to the display device of the processing system. Different instructions may be needed to generate the display, depending on which type of device receives the display.

In process 300, if a marketer does not have a user account with the offer system, the marketer will register with the system as shown in step 312. Registration processes for web based systems are known to those skilled in the art. A typical registration process will collect information from the user and ultimately create a user account for that user.

In step 315, process 300 receives a request for an option to be performed. The option may either be received as a request from a workstation or as an input into the processing system depending upon how the interface is being executed. For example, the request may be a “click” on a “button” of the screen if the processing system is directly performing the process or a request message generated by a workstation in response to a click on a button on the display of the workstation if a workstation is connected to the processing system executing process 300.

Process 300 then determines which option was requested. In step 325, process 300 determines whether a “post offer” request was received. If a post offer request was received, process 300 performs a post offer process in step 327 and then process 300 returns to steps 315 to receive another option. Otherwise, process 300 continues to step 330.

In step 330, process 300 determines whether a view/edit offer request was received. If a view/edit offer request was received, process 300 performs view/edit offer process in step 332 and then process 300 returns to steps 315 to receive another option. Otherwise, process 300 continues to step 335.

In step 335, process 300 determines whether a view analytics request was received. If a view analytics request was received, process 300 performs the view analytics process in step 337 and then process 300 returns to steps 315 to receive another option. Otherwise, process 300 continues to step 340.

In step 340, process 300 determines whether a view commitments request was received. If a view commitments request was received, process 300 performs view commitments process in step 342 and then process 300 returns to steps 315 to receive another option. Otherwise, process 300 continues to step 345.

In step 345, process 300 determines whether a quit or exit command is received. If a quit request is received process 300 ends. Otherwise process 300 returns to 315 to receive another option.

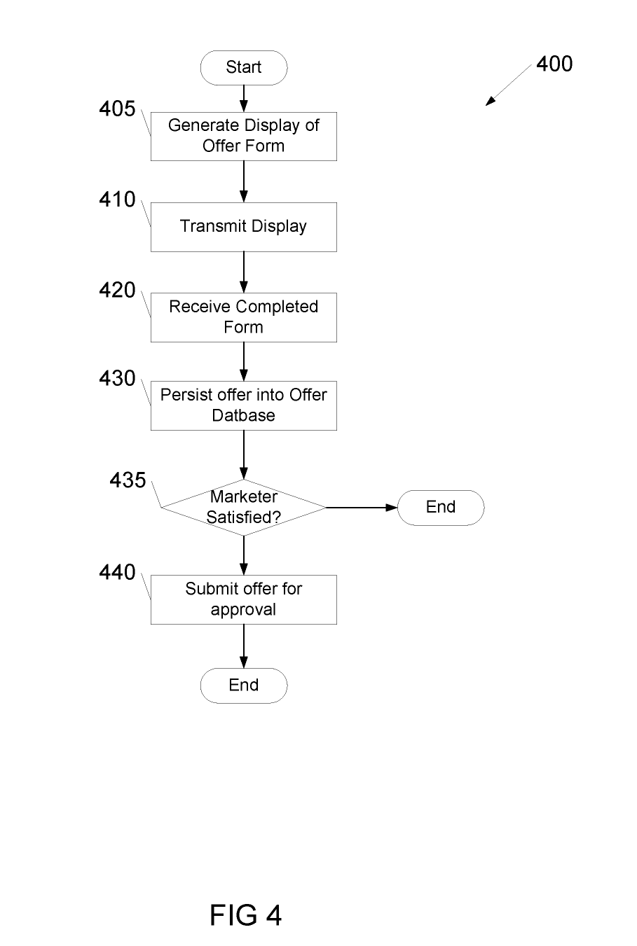

FIG. 4 illustrates a flow diagram of a process 400 for posting an offer into the offer database.

Process 400 begins at step 405 by generating a display of an offer form. The display is then transmitted either to a display device or another system in step 410. The offer form has fields in the form of text boxes and drop downs and other controls familiar to those skilled in the art. This form asks the marketing user to provide all information that makes up the display of the offer including but not limited to the offer title, description, cost, and image to be displayed to qualified consumers. Additionally the form collects information from the marketing user including the offer terms, expiration date, available units, and redemption information that describes to the user how the user can redeem the offer that is being requested.

Notably the marketing user will also be asked to provide a geographic area that limits the availability of the offer and a minimum desirability score or ranking for the given offer. The desirability criteria may be expressed as a ranking or a score. As an example, a marketing user may identify that the offer is only for users in the top 10% of the population via some desirability measure that may include social influence. In this example, consider that the marketing user will use a selection user interface control to select an offer criterion such as “top 1% of influencers.” Alternatively the marketer may identify that the minimum desirability ranking is within a specific region such as “top 20% of influencers in New York City.” Alternatively the marketer may identify that the minimum desirability score as a fixed value such as “score of 500 or higher.”

A variable minimum score feature may be provided to the marketer in which a minimum score or rank is provided but a schedule is also provided by the marketer for how the score can be decreased. It is advantageous to allow a marketer to specify a schedule for decreasing the offer minimum so that the offer is first made available to the most desirable consumers and then over time is available for the less desirable consumers.

Upon completing the form, or while completing the form, the marketing user can see a “preview” of the offer indicating what the offer will look like when it is displayed to consumer. After the offer form is filled in, the data from the form is received by the offer server processing unit 420 and will be persisted to (i.e., stored in) the offer database in step 430.

When the marketer is satisfied with the offer, the offer will then be submitted for approval in step 440. Once the offer is approved by a system administrator or other user, the offer is available for consumption by the qualified consumer users.

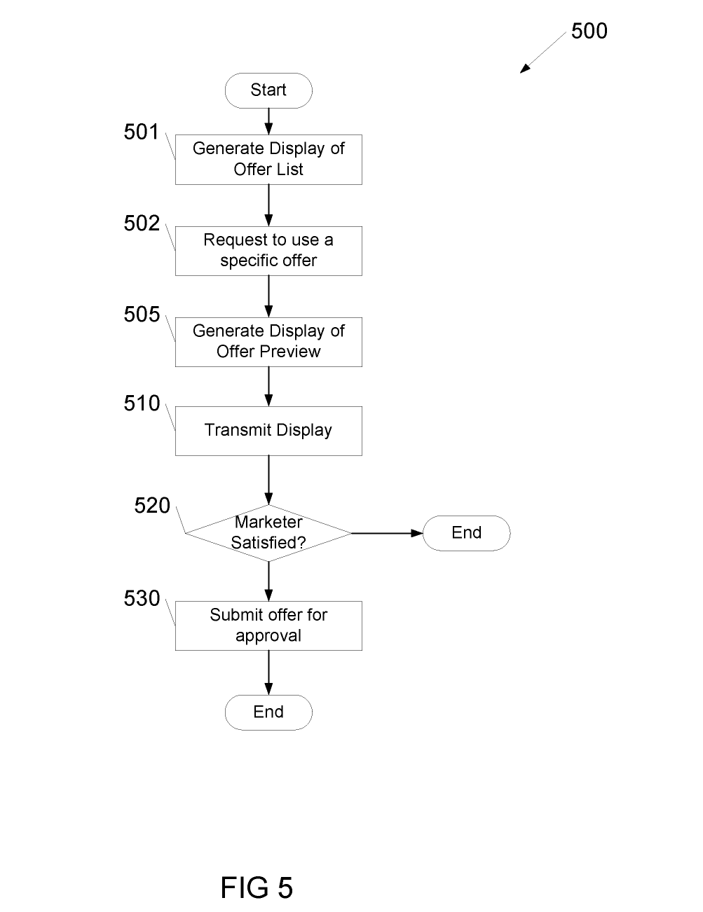

FIG. 5 illustrates a flow diagram of a process 500 for viewing/editing an offer in the offer database.

Process 500 begins at step 501 by generating a display of the list of offers that were posted or created by the marketer. In step 502, the system receives a request from the marketer to use a specific offer for the next step. In step 505 a display is generated of the offer in a “preview” state, that is as it will be shown to an end user. The display is then transmitted either to a display device or another system in step 510. The preview of the offer may show the offer on a mobile device or multiple views of the offer on multiple images of devices. This is advantageous to the marketer, as they can preview what the offer will look like to the end consumer that they are trying to attract. If the offer is not yet submitted for approval, the marketer may review it and submit it for approval at this stage. If the offer needs to be modified or edited, the user may do so using process 400. Process 400 will generate the offer form for the user with the desired offer information already filled in so as to enable the editing of the offer.

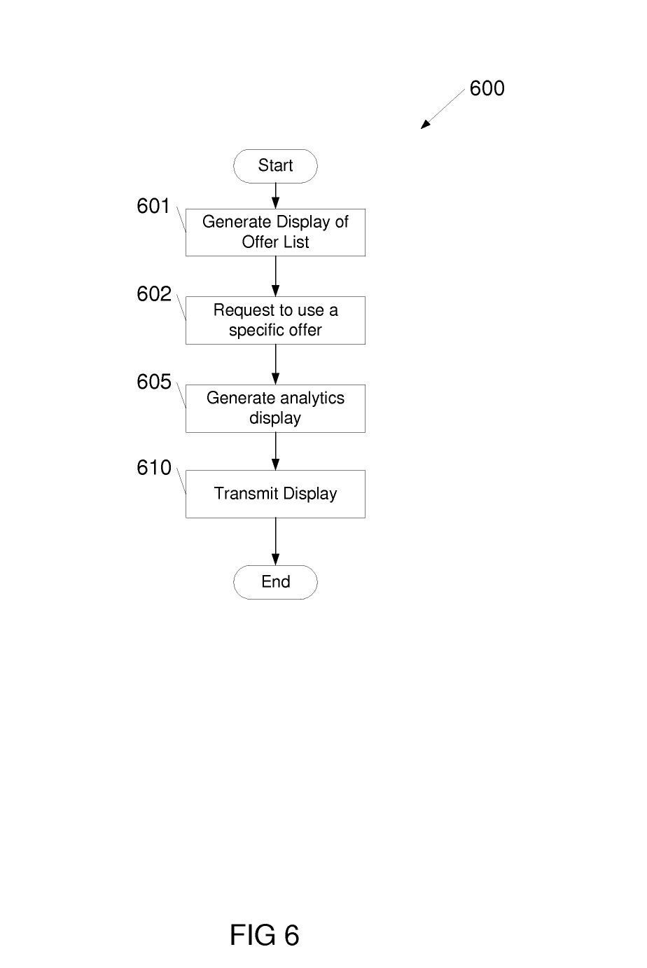

FIG. 6 illustrates a flow diagram of a process 600 for viewing analytics of an offer in the offer database.

Process 600 begins at step 601 by generating a display of the list of offers that are posted or created by the marketer. In step 602, the system receives a request from the marketer to use a specific offer for the next step. In step 605 a display is generated showing dashboards and graphs about the offer that was selected. These dashboards and graphs contain information regarding impressions, clicks, commitments, and other statistical information that may be relevant to the marketer. Various techniques may be used to collect this information and generate corresponding dashboards, graphs and other summarizations. The display is then transmitted either to a display device or another system in step 610.

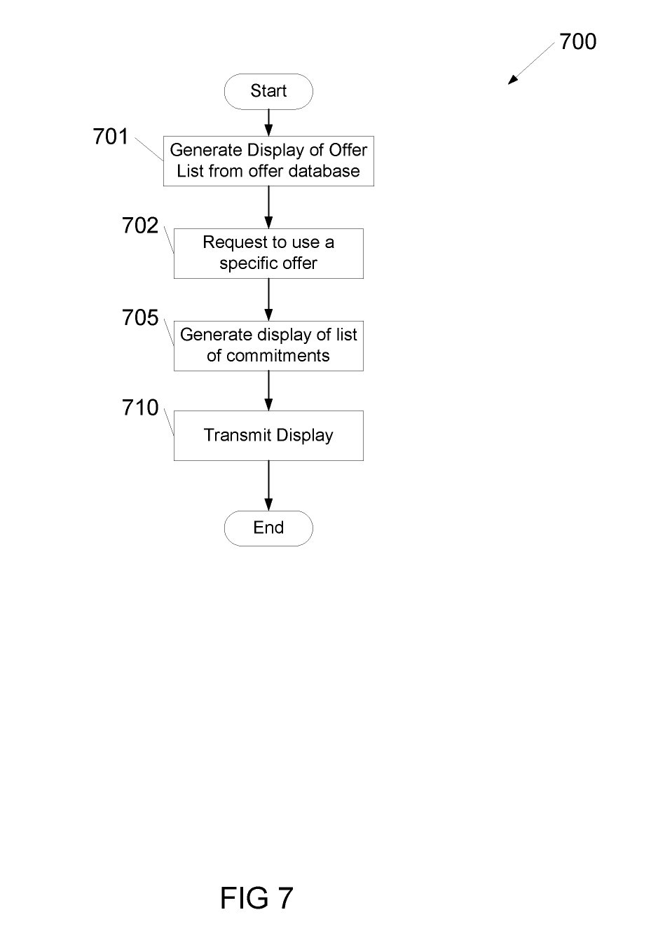

FIG. 7 illustrates a flow diagram of a process 700 for viewing commitments that have been received on an offer in the offer database.

Process 700 begins at step 701 by generating a display of the list of offers that are posted or created by the marketer. In step 702, the system receives a request from the marketer to use a specific offer for the next step. In step 705 a display is generated showing the list of commitments or reservations (e.g., redemption codes) that were issued by the system to consumer users. This display is used by the marketer to reconcile requests for the offers that are received from consumer users. Consumer users use a client application to reserve an offer and are thereby issued a voucher or reservation for the offer that includes a redemption code. The functionality of process 700 gives the marketer a way to reconcile the redemption codes presented by the consumer inside the system. This ensures that only qualified users (e.g., those with appropriate desirability scores) get the offers that were intended for them.

In accordance with the disclosed embodiments, an interface is provided that a consumer may use on a mobile device or other Internet enabled device, as discussed in further detail below, to connect to a services layer as well as a local client database. The interface may be provided by software executed by a processing system on a mobile device or a computer such as a desktop or laptop computer, or may be executed by a server that is in communication with a workstation over a network using a browser or other access software.

When the consumer accesses the system the interface provides a display that will provide the consumer with the options available by the interface to the consumer. Preferably, the display is a “Windows” type display with activation “buttons” for each option. The user can then select an option by “clicking” on the activation button for the option using their finger (if the device is a mobile device) or a pointing device such as a mouse. Alternatively, the interface may have various menus or tabs that may be accessed in order to chose an option.

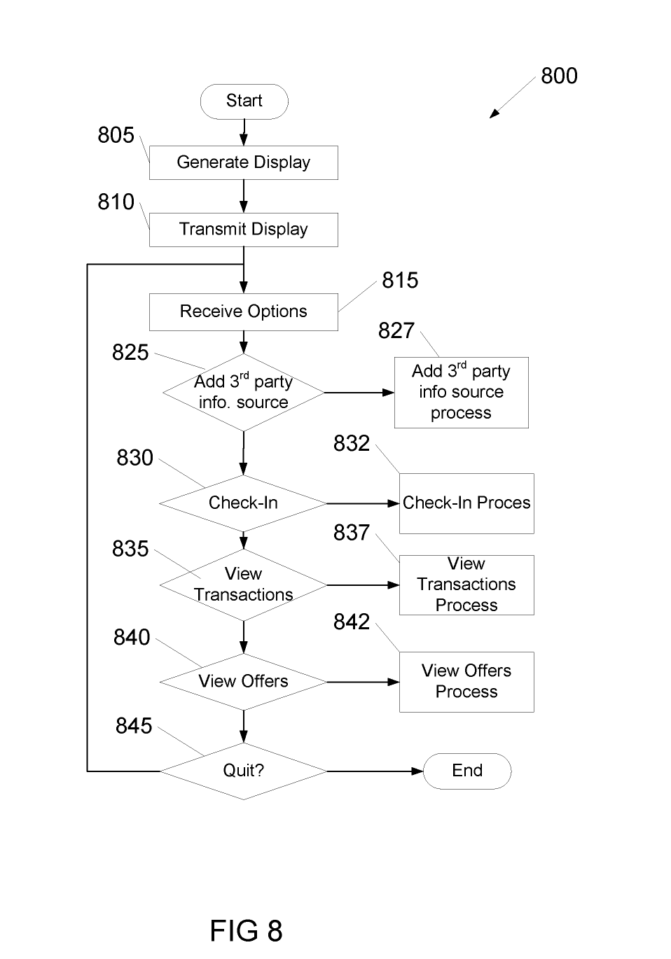

FIG. 8 illustrates a flow diagram of a process 800 executed to provide the interface using the above described display. Process 800 begins in step 805 in which the display is generated by the processing unit in the processing system executing process 800.

In step 815, process 800 receives a request for an option to be performed. The option may either be received as a request from a mobile device as an input into the processing system depending upon how the interface is being executed. For example, the request may be a “click” on a “button” of the screen if the processing system is directly performing the process or a request message generated by a workstation in response to a click on a button on the display of the workstation if a workstation is connected to the processing system executing process 800.

Process 800 then determines which option was requested. In step 825, process 800 determines whether an add information source request was received. If an add information source request was received, process 800 performs an add information source process in step 827 and then process 800 returns to steps 815 to receive another option. Otherwise, process 800 continues to step 830.

In step 830, process 800 determines whether a check-in request was received. If a check-in request was received, process 800 performs a check-in operation in step 832 and then process 800 returns to steps 815 to receive another option. Otherwise, process 800 continues to step 835.

In step 835, process 800 determines whether a view transactions request was received. If a view transactions request was received, process 800 performs a view transactions operation in step 837 and then process 800 returns to steps 815 to receive another option. Otherwise, process 800 continues to step 840.

In step 840, process 800 determines whether a view offers request was received. If a view offers request was received, process 800 performs a view offers operation in step 842 and then process 800 returns to steps 815 to receive another option. Otherwise, process 800 continues to step 845.

In step 845, process 800 determines whether a quit or exit command is received. If a quit request is received process 800 ends. Otherwise process 800 returns to 815 to receive another option.

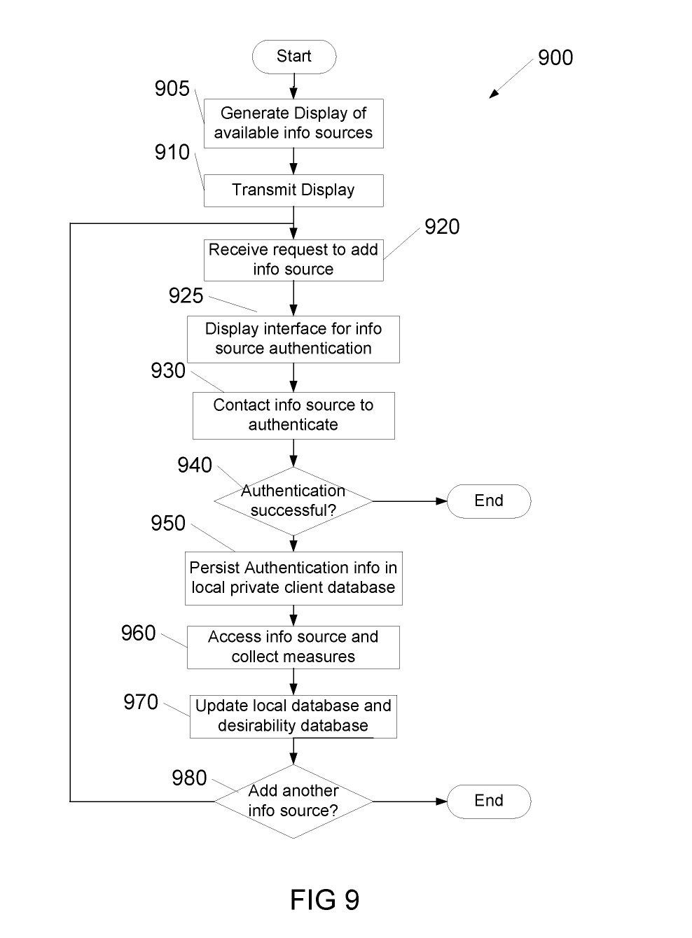

FIG. 9 illustrates a flow diagram of a process 900 for adding an information source.

Process 900 begins at step 905 by generating a display of a list of available information sources, e.g., Facebook and Twitter. The display is then transmitted either to a display device or another system in step 910. The user selects an information source that is supported by the platform and where the user has an account and the request is received by process 900 in step 920. Process 900 then displays an authentication user interface in step 925 to allow the consumer user to authorize the system to contact the information source on behalf of the consumer user. This may be accomplished using application programming interfaces (APIs), where that API is available and provided as a service by the given information source.

Although any API style may be used, there is a type of API that is known as the OAuth standard. It is advantageous to use an API that supports the OAuth standard, because it does not require the user to trust the offer system with his credentials. Instead, using a protocol such as OAuth (where available), the user can enable the application to access the information source on behalf of the user without actually providing the system with his credentials. This is not required but is desirable. If the user is unable to provide valid credentials, the process cannot access the third party information source on behalf of the user and the authentication fails, ending process 900. If the user is able to provide valid credentials, either those credentials (in the case where the information source does not use an OAuth style protocol API), or an access token (a result of a successful OAuth authentication) will be persisted in the local private client database as show in step 950. This is done so that the user only needs to provide the authentication information once—thereby establishing a trust relationship between the application and the third party information source. After this authentication is complete, process 900 will continue to step 960, where the system accesses the third party information source on behalf of the user and collects a series of measures that are preprogrammed.

In one embodiment of the invention, where social influence is used as a desirability indicator, the third party information sources are likely to be social networks that users may be members of. In this instance the measures collected may include size of user's social network and number of posts or transactions conducted by the user in the last 30 days. These are merely shown as examples and are not meant to constrain the scope of the invention. Other more sophisticated measures may be collected. Once the measures are collected, they are stored on the local private client database and then also transmitted to the offer services layer that will persist the measures into the desirability database for further analysis and scoring as shown in step 970. After adding an information source, the process can repeat to allow the user to add any other information sources that they have profiles with as shown in step 980.

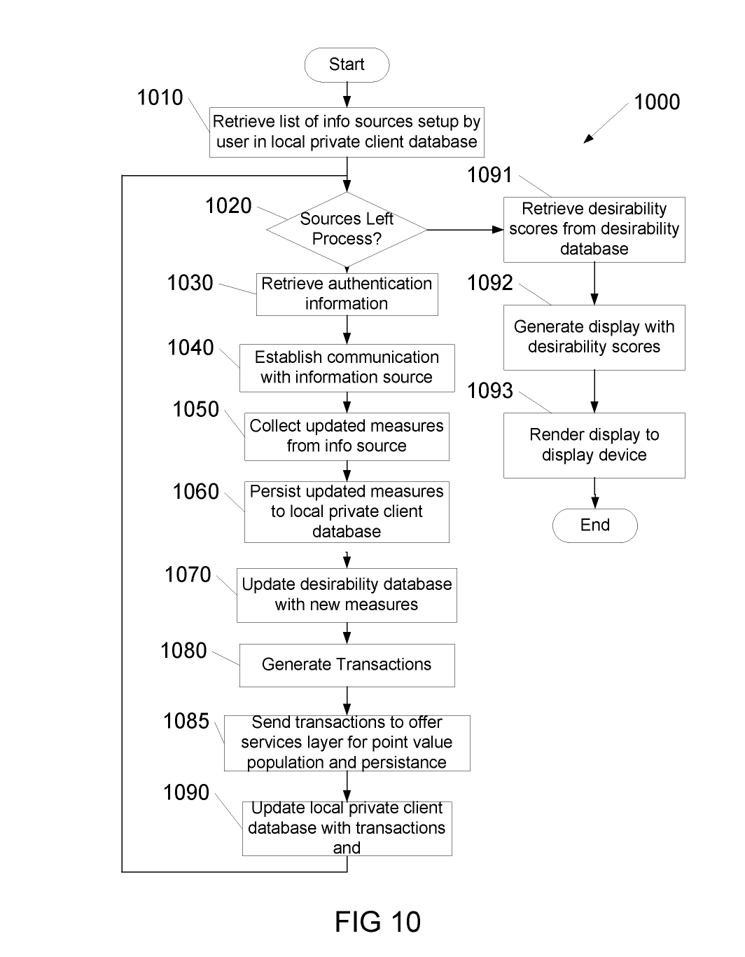

FIG. 10 illustrates a flow diagram of a process 1000 for conducting a check-in operation.

The check-in process is used to update the user's desirability score. Process 1000 begins at step 1010 by accessing the local private client database to gather a list of 3^{rd} party information sources that have been authorized by the user. For each 3^{rd} party information source that was authorized by the user, steps 1030 to 1090 are executed.

First in step 1030 the process retrieves the access token or credential information that was provided by the user when the user when the user added the 3^{rd} party information source as in process 900. Next, using this access token and the appropriate APIs, the process interacts with the 3^{rd} party information source to establish a session in step 1040 and ultimately collects an updated set of measures in step 1050. The updated measures are persisted to the local private client database in step 1060 and then in step 1070 the offer service layer is contacted and the offer service layer updates the desirability database.

In step 1080 the process compares the measures collected now with the measures previously collected and generates a series of transactions for each measure. As an example, consider that a 3^{rd} party information source is a social network and the measure being collected is the number of friends the user has on that social network, consider that the last time the measure was collected the value was 10 (indicating the user had 10 friends) now the measure has a value of 12. In this example a transaction may be generated indicating that there is a difference (+2 friends).

The transactions are sent to the offer services layer in step 1085 and the offer services layer identifies the point value for those transactions and updates the transactions and persists the transactions in the desirability database and returns the transactions with the point value now populated on the transactions. As an example consider the transaction indicating the difference of +2 friends. This could be created as a single transaction or as multiple transactions, one for each friend that was added. A point value could be associated with each addition of a friend for this social network of (as an example) 2 points. The result of this would then be that 4 points are added to the desirability score of the user. The populated transactions are then persisted in the local private client database in step 1090.

Such a model for updating the transactions allows the offer services layer to provide varying points in the desirability score depending on the type of transaction and the specific information source. Consider that one 3^{rd} party information source is weighted differently than another in the scoring model—this can easily be accomplished by assigning different point values to the transactions based on the 3^{rd} party information source. As a practical example, adding friends or followers on one social network may be less indicative of social influence (and therefore desirability) than another, therefore the offer services layer may assign a lesser point value to the transactions associated with this 3^{rd} party information source (social network).

Additional transactions that are created from the server may also be injected into the transaction list—as an example consider a situation wherein a promotion is designed to incentivize a user to do a “share” operation on their social networks to tell their friends about the platform itself. One can see that in such a situation, a bonus transaction of additional points may be awarded to the user.

Since the design of the system is such that the transactions are sent from the client to the offer services layer, and then the returned list is what is persisted and then displayed, the server may inject any number of other transactions based on other factors. As an example consider the simple case of platform use. Continued usage of the platform may be desirable behavior and therefore the user may be incentivized by awarding the user with points for such behavior (by creating transactions on the server side as indicated above). Since the offer services layer records the operations and contacts from the server in the offer database and desirability databases it can easily be used to create other transactions for the user.

Once there are no more 3^{rd} party information sources to update, process 1000 executes step 1091 which contacts the offer services layer to retrieve the user's score. While the score can consist of many components, the present embodiment returns two scores—one is a fixed point value and one is a relative score, e.g., the ranking of the current user against others in the given geographic area.

A display is generated with the updated scores in step 1092 and then rendered to the display device in step 1093. A visual indicator may be used to show the score in an attract way, so as to make the user feel that he is playing a game. This is advantageous because it brings the user back and encourages them to increase their score through various means (an increase in the users score implies an increase in their desirability which means that they get access to better (more discounted) offers.

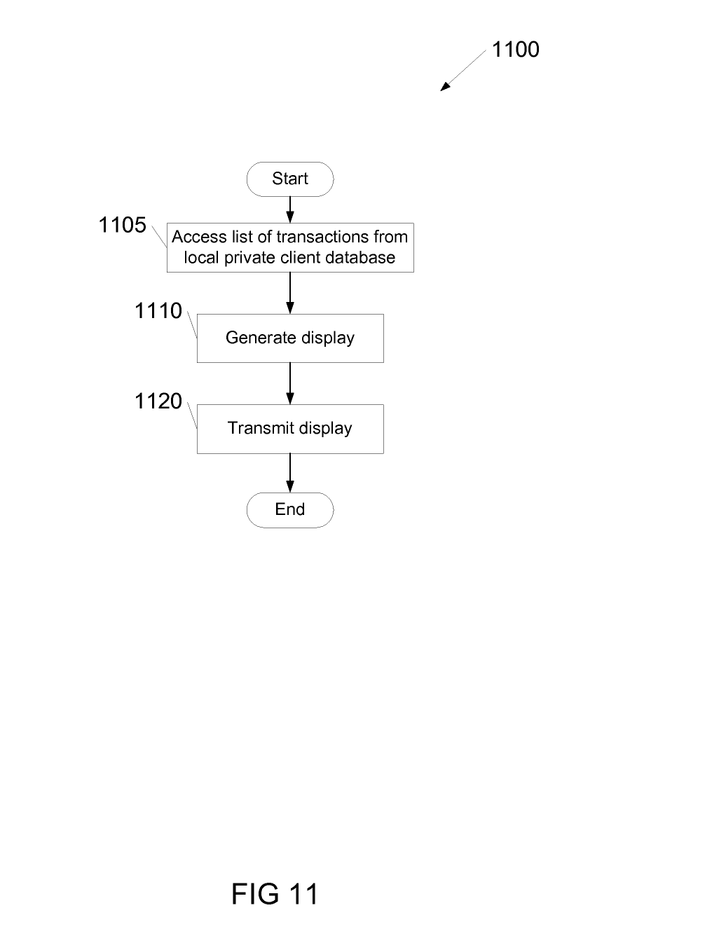

FIG. 11 illustrates a flow diagram of a process 1100 for displaying transactions.

Process 1100 begins at step 1105 in which it accesses the local private client database to gather a list of transactions that have been persisted. A display is generated in step 1110 of the transactions and then transmitted or rendered to the user's display device in 1120.

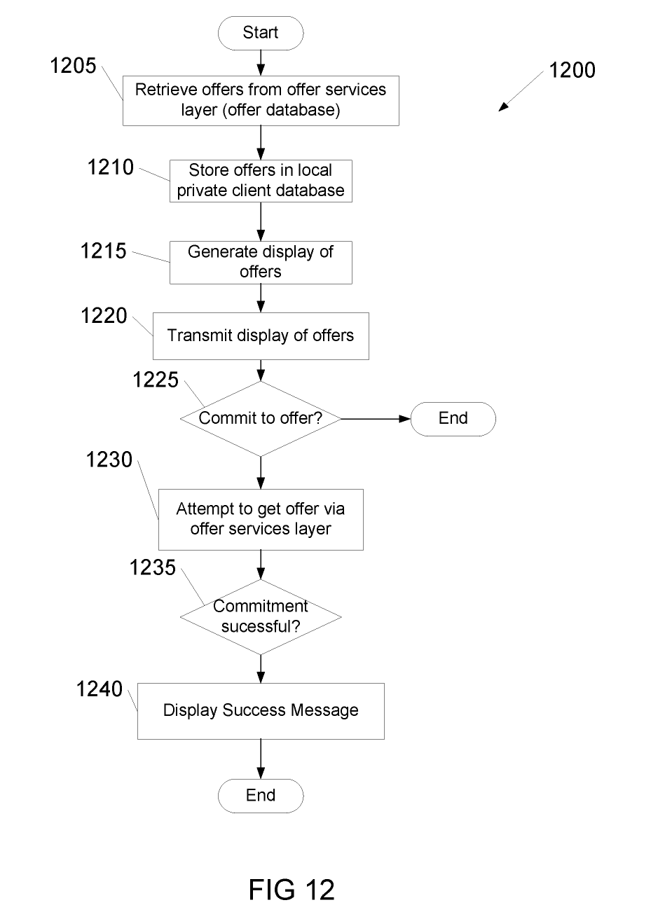

FIG. 12 illustrates a flow diagram of a process 1200 for displaying offers.

Process 1200 begins at step 1205 in which it contacts the offer services layer to retrieve a set of offers for the given user. If the user's device supports global position system (GPS) coordinates then this information on the user's current location will also be transmitted to the offer services layer. The offer services layer checks the minimum desirability score or ranking for the list of offers that have units available (inventory) and are not expired and compares them with the users desirability score and rating as persisted in the desirability database (in addition to other criteria such as the location of the user). A given offer may be defined with a cost table that defines the price of the product or service as it relates to the desirability of the consumer. As the desirability increases, the cost the product may decrease. Both of these approaches to defining offers, i.e. one in which separate offers are produced each with a minimum desirability score, or one in which a single given offer has multiple costs associated with it depending on the desirability of the user, may be used in a given implementation.

The offers are then returned to the consumer client application and are stored in the local private client database in step 1210. A display of the offers is then generated in step 1215 and the offers are shown to the user after the display is transmitted or rendered in step 1220. The user may browse offers and then decide not to select any offers in which case process 1200 ends. If the user decides that they want to commit to an offer, then the user will indicate this via the user interface (a button or other selection) and the step 1230 will be executed. An optional step may be considered (not depicted) wherein the user is required to post on their social networks or further increase their desirability in order to access an offer. While providing the details of the offer the marketer may indicate that this step is required in order for the user to access the offer.

Step 1230 results in the offer services layer being contacted. The offer services layer then determines if the user's current score and rank as is listed in the desirability database is sufficient to access the offer, and also that the offer currently is not expired and has units available. If the user cannot get the offer per the assessment of the offer services layer, then an error is returned, displayed to the user and the process ends. If the offer services layer determines that the user can get the offer (per the criteria just described) then the offer services layer generates a random redemption code and updates the offer database with a commitment record that indicates that the given consumer has a reservation on this offer. The offer services layer then uses an email server to send an email to the consumer with the redemption code. A success message indicating the redemption code was emailed to the user can be then displayed to the user in step 1240 or the redemption code itself can also be displayed.

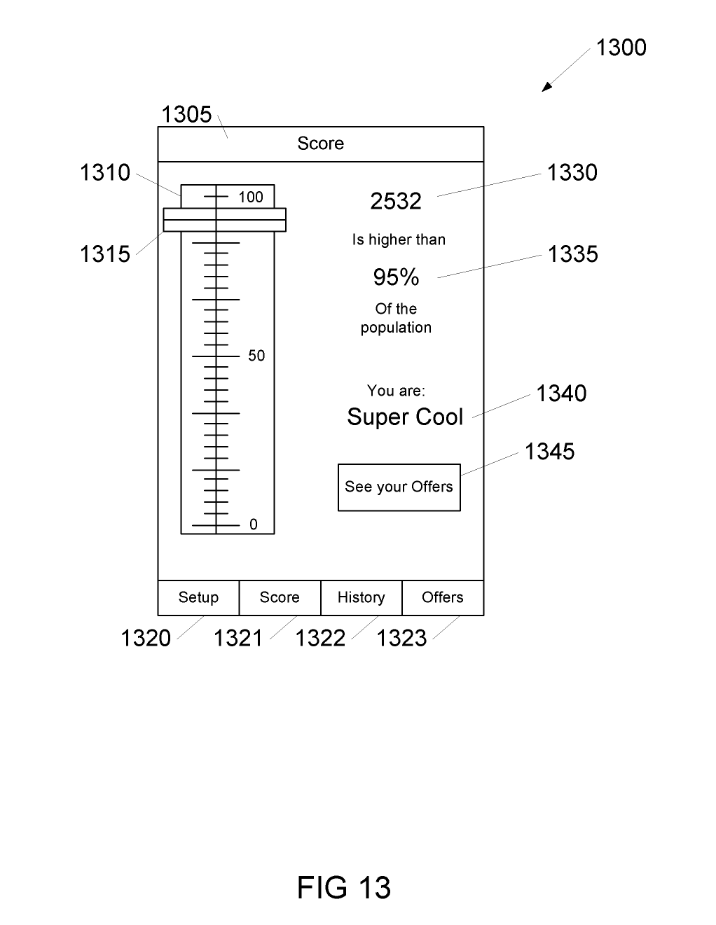

FIG. 13 illustrates a user interface mockup showing a window or mobile device user interface 1300. User interface 1300 includes a navigation area including buttons or tabs 1320 to 1323. As a user presses each button or tab the overall view changes. The current view shows the view that is the score view. A title 1305 is shown on the view that indicates that the score view is currently selected. As a user switches to this view by pressing button 1321 the view updates showing an updated score via label 1330 and a relative score via label 1335. Additionally a label 1340 may be used to indicate some text describing the user's popularity. If the user will have a list of offers because of their score, a button 1345 may be visible to the user indicating that they have offers available to review. If the user taps or clicks the button 1345, the user will be taken to the offers view.

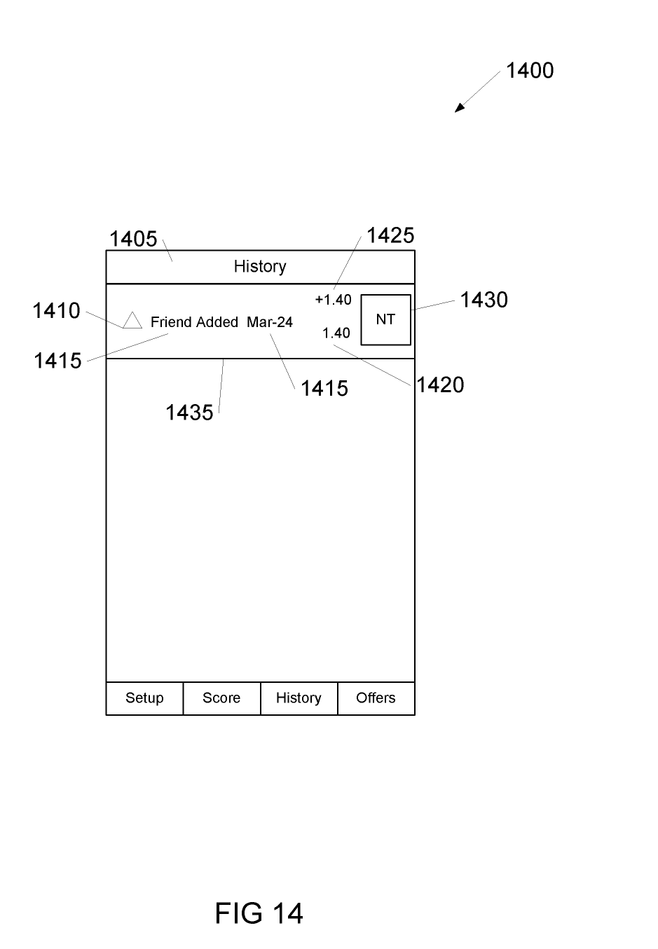

FIG. 14 illustrates a user interface mockup showing a window or mobile device user interface 1400. User interface 1400 is a history or transaction view that shows a list of transactions that affect the users score. A title 1405 is shown to indicate to the user that the history view is currently selected. A visual indicator 1410 is shown to indicate if the transaction positively or negatively affects the users score (consider an arrow showing up or down as one possible indicator). A label showing the transaction name 1415 is shown for a given transaction. The transaction name indicates the specific activity that affected the user's score. A label showing the date the transaction occurred 1415 is also shown to the user for the transaction. Each transaction's point value (the amount it affects the users' score by) is shown via label 1425. A total balance label 1420 is shown with each transaction. A transaction image 1430 is displayed to the user to indicate the type of transaction or the specific data source which was used to derive the transaction. Consider the situation in which the data sources are social networks that the user is a member of, in this instance the transaction image 1430 may be the logo of the social network for those transactions that involve that social network. For each transaction section 1435 may be repeated.

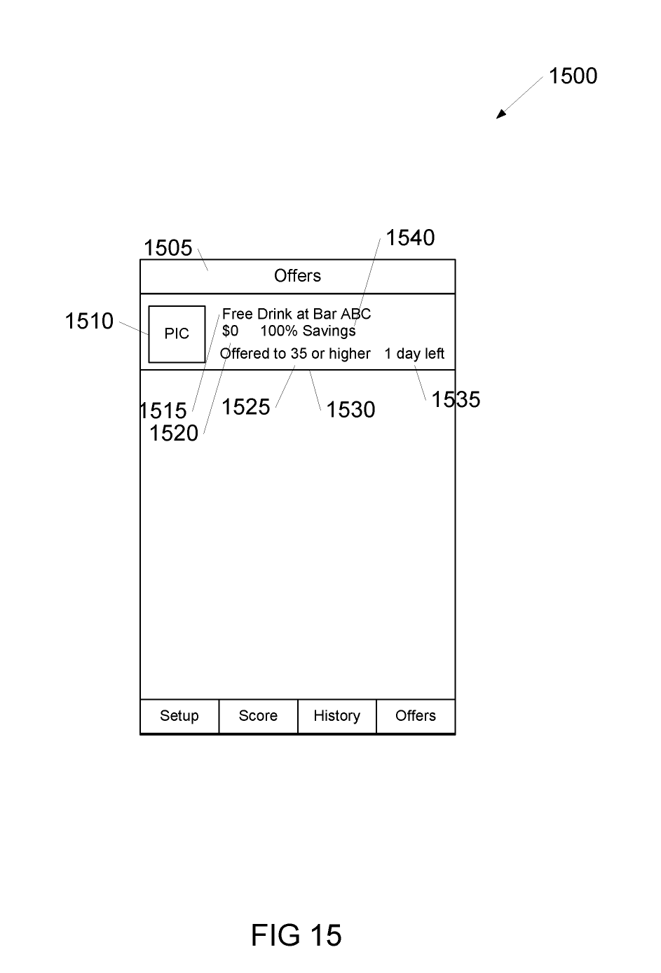

FIG. 15 illustrates a user interface mockup showing a window or mobile device user interface 1500. User interface 1500 is an offer listing view that shows the user the list of offers that are available. A title 1505 is shown to indicate to the user that the offer view is currently selected. A section 1530 is repeated for each offer. Within section 1530 there are labels and controls that describe an offer. An image 1510 is shown to the user for that offer. An offer title label is shown to indicate to the user what the offer is. An offer price label 1520 is shown to indicate to the user the out of pocket price. A message indicating the exclusivity of the offer is shown to the user via label 1525. Users are also shown a text that indicates how much longer the offer is available for selection via label 1535. Users tab on a section 1530 in order to select an offer and view more details about the offer.

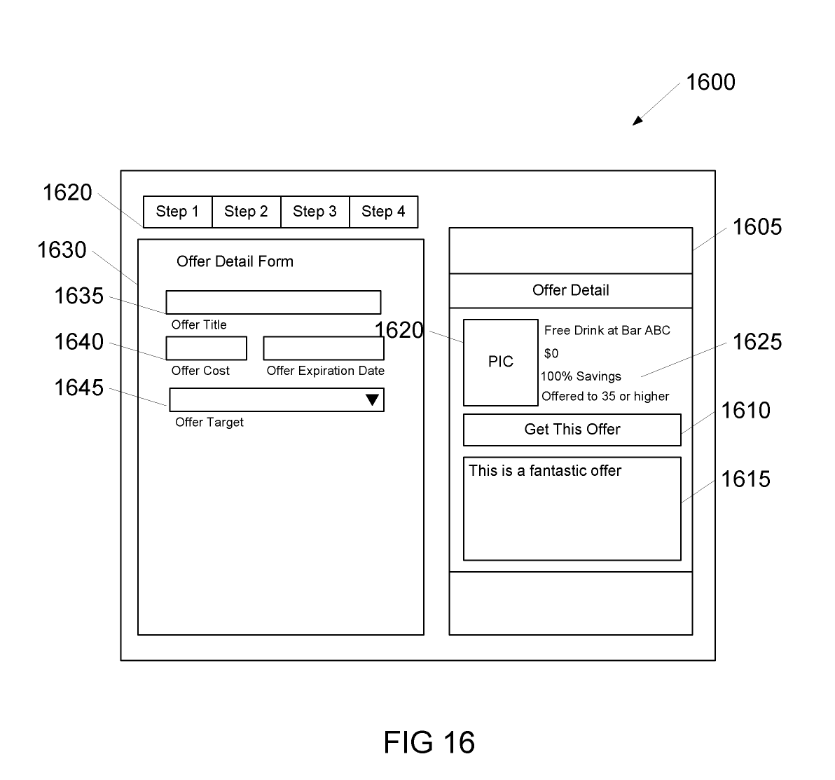

FIG. 16 illustrates a user interface mockup showing a window based user interface 1600. User interface 1600 is the user interface in the offer portal that is used by a marketing user to submit offers to the system. A navigation bar 1620 allows the user to select a given offer sub-form. As the user selects a button in the navigation bar, an offer sub-from that corresponds with the button is displayed in section 1630. Marketing users fill-in the offer form sub-section using text fields, drop-downs and other user interface controls.

For illustrative purposes FIG. 16 shows a state of the user interface in which the offer overview sub-section of the offer form is shown. User interface controls 1635 to 1645 are used by the marketing user to submit information about the current offer to the system. User interface control 1645 is an offer target drop down style control that when clicked or pressed provides a list of options that the user can select. Offer target options displayed when the control is clicked or pressed may include things such as “top 10%” or “top 20%.” In this manner this control allows the user to select a minimum desirability rating for this offer. As an example, consider the case in which the marketing user selects “top 10%” as an option. In this case, the offer will only be available to those users that have a score greater than 90% of the other users in the given market (or city). As a user enters values into the offer detail form, a preview of the offer may be shown to the marketing user so that the marketing user can see what the offer will look like when it is shown to the user in the consumer application. The preview of the offer is shown to the users via an image or visual depiction 1605 that shows a mockup of the offer as it will be shown to the consumer user. Notations on FIGS. 16 1610, 1615, 1620 and 1625 are areas of the offer preview screen.

The advantages of the disclosed embodiments include, without limitation, the ability for marketers and businesses to maximize profits while maximizing word of mouth marketing by attracting desirable consumers such as social influencers with exclusive offers that are conditional upon their social influence.

In broad embodiment, the present invention is a software system for connecting consumers with marketers that want to give those consumers offers—wherein the desirability of the user is taken into account in what offers are presented to the user, or what price or cost an offer has.

While the foregoing written description of the invention enables persons skilled in the art of software development to make and use what is considered presently to be the best mode thereof, those skilled in the art of software development will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of providing marketing offers to a user based upon desirability of the user, comprising the steps of:
retrieving at least one marketing offer from an offer database;
retrieving a desirability score of a user from a desirability database;
generating a display to appear on a client computer showing at least one marketing offer with a minimum desirability score less than the desirability score of the user, wherein the desirability score of the user is based at least partly upon a metric.

2. The method according to claim 1, wherein a number of points assigned by the metric depends upon a number of friends that the user has on at least one social network, wherein a weighting value may be assigned to each social network.

3. The method according to claim 1, wherein a number of points assigned by the metric depends upon a number of transactions that the user has made on at least one social network, wherein a weighting value may be assigned to each social network.

4. The method according to claim 1, wherein the desirability score of the user relates to participation in a loyalty program.

5. The method according to claim 1, wherein a number of bonus points is added to the desirability score of the user when the user performs a desired task.

6. The computer program product according to claim 1, wherein the instructions to display at least one marketing offer further comprises instructions to display the minimum desirability score of the at least one marketing offer.

7. The method according to claim 1, further comprising the steps of:
displaying the desirability score of the user;
displaying at least one transaction affecting the desirability score of the user; and
displaying prospective effects of future transactions upon the desirability score of the user.

8. The method according to claim 1, further comprising the steps of:
selecting at least one of the at least one marketing offers using a user interface;
determining if the user qualifies for the selected offer;
reserving a selected offer using the user interface; and
providing a redemption code corresponding to the reserved offer.

9. The method according to claim 8, further comprising a step of decrementing a number of available units of the reserved offer.

10. The method according to claim 8, wherein the user must perform a transaction on a social network before redeeming the reserved offer.

11. A computer program product stored on a non-transient computer storage medium, comprising the following instructions to execute steps to providing marketing offers to a user based upon desirability of the user:
instructions to retrieve at least one marketing offer from an offer database;
instructions to retrieve a desirability score of a user from a desirability database;
instructions to generate a display to appear on a client computer showing at least one marketing offer with a minimum desirability score less than the desirability score of the user, wherein the desirability score of the user is based at least partly upon a metric.

12. The computer program product according to claim 11, wherein a number of points assigned by the metric depends upon a number of friends that the user has on at least one social network, wherein a weighting value may be assigned to each social network.

13. The computer program product according to claim 11, wherein a number of points assigned by the metric depends upon a number of transactions that the user has made on at least one social network, wherein a weighting value may be assigned to each social network.

14. The computer program product according to claim 11, further including instructions to add a number of bonus points to the desirability score of the user when the user performs a desired task.

15. The computer program product according to claim 11, wherein the desirability score of the user relates to participation in a loyalty program.

16. The computer program product according to claim 11, wherein the instructions to display at least one marketing offer further comprises instructions to display the minimum desirability score of the at least one marketing offer.

17. The computer program product according to claim 11, further comprising:
instructions to display the desirability score of the user;
instructions to display at least one transaction affecting the desirability score of the user; and
instructions to display prospective effects of future transactions upon the desirability score of the user.

18. The computer program product according to claim 11, further comprising the steps of:
instructions to select at least one of the at least one marketing offers using a user interface;
instructions to determine if the user qualifies for the selected offer;
instructions to reserve a selected offer using the user interface; and
instructions to provide a redemption code corresponding to the reserved offer.

19. The computer program product according to claim 18, further comprising instructions to decrement a number of available units of the reserved offer.

20. The computer program product according to claim 18, further comprising instructions to check that the user has performed a transaction on a social network before redeeming the reserved offer.

21. A system for a marketer to provide marketing offers to users based upon desirability of the user, comprising:
a marketer interface for at least one marketer to submit details of at least one marketing offer, the details including a minimum desirability score for each marketing offer;
a desirability database storing the desirability score of at least one user;
an offer database storing the offer details therein;
an offer server configured to determine if a specific user qualifies for at least one marketing offer based at least upon a desirability score of the specific user, and to generate a redemption code if the specific user qualifies; and
an email server to send an email to the user, the email including the redemption code.

22. The system according to claim 21, wherein the details include a limitation to a geographic area.

23. The system according to claim 21, wherein the details include a schedule for reducing the minimum desirability score over time.

24. The system according to claim 21, further including at least one information server, the at least one information server providing information to the offer server, the information relating to the desirability score of the at least one user.

25. The system according to claim 24, wherein the information includes either a number of friends that the at least one user has on at least one social network or a number of transactions that the at least one user has made on at least one social network or information relating to participation in a loyalty program.
